(19) United States
(12) Patent Application Publication
(10) Pub. No.: US 2015/0145957 A1
(43) Pub. Date: May 28, 2015

(54) THREE DIMENSIONAL SCANNER AND THREE DIMENSIONAL SCANNING METHOD THEREOF

(71) Applicant: SAMSUNG ELECTRONICS CO., LTD., Suwon-si (KR)

(72) Inventors: Woo-ram Son, Seoul (KR); Han Oh, Suwon-si (KR)

(21) Appl. No.: 14/492,399

(22) Filed: Sep. 22, 2014

(30) Foreign Application Priority Data
Nov. 25, 2013 (KR) 10-2013-0143915

(51) Int. Cl. H04N 13/02

(52) U.S. Cl. CPC H04N 13/0275; H04N 13/0203
USPC 348/46

(57) ABSTRACT

A 3D scanning method is provided. The 3D scanning method includes generating first 3D scan data by performing a 3D scan job. When a predetermined user command is input, a mode of the 3D scan job is changed to a correction mode. When the 3D scan job is resumed while the correction mode is maintained, the first 3D scan data is corrected based on second 3D scan data generated by resuming the 3D scan job.

### CROSS-REFERENCE TO RELATED PATENT APPLICATIONS

This application claims priority under 35 U.S.C. §119 from Korean Patent Application No. 10-2013-0143915, filed on Nov. 25, 2013 in the Korean Intellectual Property Office, the disclosure of which is incorporated herein by reference in its entirety.

### BACKGROUND

1. Field

The present disclosure generally relates to a three dimensional (3D) scanner and a three dimensional scanning method thereof, and more particularly, to a 3D scanner where a user is able to perform a three dimensional scan easily and a 3D scanning method thereof.

2. Related Art

With the increase in research in technologies for providing a 3D image, a variety of products related to a 3D scanner and a 3D printer are being released.

As illustrated in FIG. 1, a 3D scanner scans an object in all directions, thereby providing a 3D image.

In particular, a 3D scanner is capable of providing a 3D image by scanning an object in various angles like a video camera and gradually building a 3D model. That is, the 3D scanner is capable of making a more precise image by merging scan data accumulated over time with the 3D model.

The aforementioned 3D scanning method generates an image while accumulating 3D scan data, and thus, is capable of providing a 3D image by using an average value of the accumulated data. In this regard, even though some error may occur, the 3D scanner may ignore the error in a process of obtaining the average value, and thus, provides a more stable image.

Meanwhile, in the case of the aforementioned 3D scanning method, it is difficult to reflect changes of an object to be scanned immediately. That is, when an object to be scanned is a person, and the person moves his or her body or changes a look on his or her face during the 3D scan process, a 3D image is formed by using an average value between the scanned data and changed data. That is, the 3D scanning method does not reflect the movement or facial expression on a face which is changed gradually, and as a result, a generated 3D image may be distorted or less accurate.

### SUMMARY

Various embodiments of the present disclosure provide a 3D scanner where a user is able to perform a 3D scan job easily and a 3D scanning method thereof.

A three dimensional (3D) scanning method includes: generating first 3D scan data by performing a 3D scan job; when a predetermined user command is input, changing a mode of the 3D scan to a correction mode; when the 3D scan job is resumed while the correction mode is maintained, correcting the first 3D scan data based on second 3D scan data generated by resuming the 3D scan job.

The correcting may include replacing the first 3D scan data with the second 3D scan data.

The correcting may include correcting the first 3D scan data by assigning a weight value to the second 3D scan data and merging the first 3D scan data with the weighted second 3D scan data.

The generating of the first 3D scan data may include: receiving distance information at an interval of reference unit; tracing a location of a 3D scanner which performs the 3D scan job; and merging the distance information with location information corresponding to the traced location of the 3D scanner. In addition, the correcting may include merging the first 3D scan data with the second 3D scan data.

The method may further include detecting an object. In addition, the correcting may include correcting only the first 3D scan data that corresponds to the detected object.

The method may further include receiving a user command of selecting a subarea of an area where the 3D scan job is performed. In addition, the correcting may include correcting 3D scan data of the subarea selected by the user command.

A three dimensional (3D) scanner includes: a scanning unit that performs a 3D scan job; a user input unit that receives a user command; and a controller. The controller: generates first 3D scan data from input data scanned by the scanning unit; when a user command for changing a mode of the 3D scanner is input, changes the mode to a correction mode; and when the 3D scan job is resumed while the correction mode is maintained, corrects the first 3D scan data based on second 3D scan data from the resumed 3D scan job.

The 3D scanning unit may include a depth sensor that senses distance information.

The controller may correct the first 3D scan data by replacing the first 3D scan data with the second 3D scan data from the resumed 3D scan job.

The controller may correct the first 3D scan data by assigning a weight value to the second 3D scan data from the resumed 3D scan job.

The controller may: receive distance information at an interval of reference unit; trace a location of the 3D scanner; generate the first 3D scan data by merging the distance information based on the traced location of the 3D scanner; and when the distance information is merged based on the traced location of the 3D scanner, merge the first 3D scan data with the second 3D scan data from the resumed 3D scan job.

When a user command for selecting an object is input through the user input unit, the controller may detect the selected object, and corrects the first 3D scan data corresponding to the detected object.

When a user command of selecting a subarea of an area where the 3D scan job is performed is input through the user input unit, the controller may correct only the first 3D scan data corresponding to the subarea selected by the user command.

The scanner may further include a display having a touch panel. In addition, the user command of selecting a subarea of an area where the 3D scan job may be input with a touch input through the display.

A three dimensional (3D) scanning method includes: generating first 3D scan data by performing a 3D scan job; when a predetermined user command is input, pausing the generation of the first 3D scan job; and when the 3D scan job is resumed while the generation of the first 3D scan data is paused, resuming the 3D scan job without generating the first 3D scan data.

When the predetermined user command is selected again while the generation of the first 3D scan data is paused, the resuming comprises resuming the generating of the first 3D scan data.

A three dimensional (3D) scanner includes: a scanning unit that performs a 3D scan job; a user input unit that receives a user command; and a controller. The controller: generates first 3D scan data from input data scanned by the scanning unit; when a user command for pausing the scan job of the 3D scanner is input through the user input unit, pauses the generation of the first 3D scan data; and when the 3D scan job is resumed while the generation of the first 3D scan data is paused, resumes the 3D scan job without generating the first 3D scan data.

When the user command is selected again through the user input unit while the generation of the first 3D scan data is paused, the controller may resume generating the first 3D scan data.

According to various exemplary embodiments, a 3D scanner where a user is able to perform a 3D scan job easily and a 3D scanning method may be provided.

### BRIEF DESCRIPTION OF THE DRAWINGS

The above and/or other embodiments of the present disclosure will be more apparent by describing various embodiments of the present disclosure with reference to the accompanying drawings, in which:

FIG. 1 is a diagram illustrating a scan process and a scan result of a 3D scanner according to the prior art;

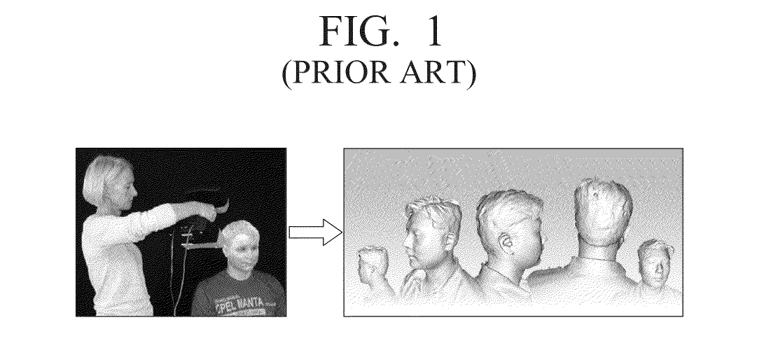

FIG. 2 is a block diagram illustrating a structure of a 3D scanner according to an embodiment;

FIG. 3 is a diagram illustrating a 3D scanner according to an embodiment;

FIG. 4 is a diagram illustrating a process of scanning a person by using a 3D scanner and a scan result thereof according to an embodiment;

FIG. 5 is a diagram illustrating a result of a 3D scan job when a facial expression on a face of a person is changed according to an embodiment;

FIG. 6 is a diagram illustrating a 3D scanner which scans a face of a person according to an embodiment;

FIG. 7 is a diagram illustrating a process of rescanning only a face of a person and a scan result thereof according to an embodiment;

FIG. 8 is a diagram illustrating a process of detecting an object from a 3D scan screen according to an embodiment;

FIG. 9 is a diagram illustrating a process of selecting an area from a display of a 3D scanner according to an embodiment;

FIG. 10 is a diagram illustrating a result where an area is selected from a display of a 3D scanner according to an embodiment;

FIG. 11 is a flow chart illustrating a 3D scan process according to an embodiment; and

FIG. 12 is a flow chart illustrating a 3D scanning method of a 3D scanner according to an embodiment.

### DETAILED DESCRIPTION

Various embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of various embodiments. However, various embodiments can be practiced without those specifically defined matters. Also, well-known functions or constructions are not described in detail where they might obscure the application with unnecessary detail.

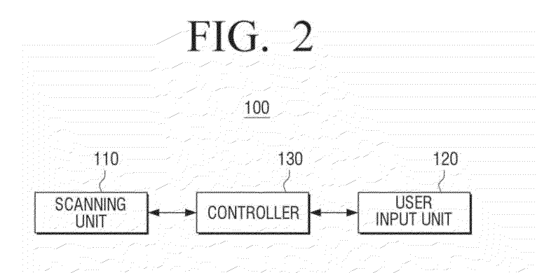

FIG. 2 is a block diagram illustrating a structure of a 3D scanner 100 according to an embodiment. As illustrated in FIG. 2, the 3D scanner 100 includes a scanning unit 110, a user input unit 120, and a controller 130.

The scanning unit 110 is a component for performing a 3D scan job. That is, the scanning unit 110 may obtain a 3D image by scanning an object.

In addition, the scanning unit 110 may include a depth sensor configured to sense distance information. The depth sensor may obtain a 3D image by sensing a distance between the 3D scanner 100 and an object to be scanned. When a 3D space is divided into voxels in a 3D array, the depth sensor may sense a distance between the 3D scanner 100 and a surface of objects located on each voxel.

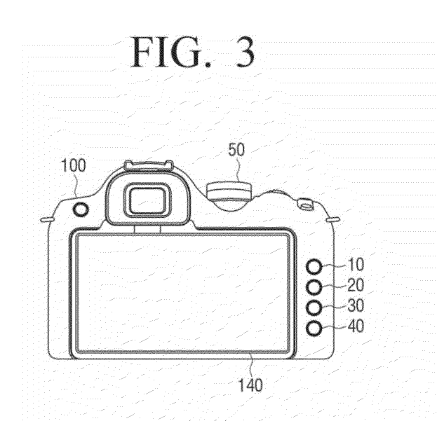

The user input unit 120 is a component for inputting a user command. The user input unit 120 may exist in a form of hardware such as a button on a part of the 3D scanner 100. Alternatively, when the 3D scanner 100 includes a display 140 (FIG. 3) and the display 140 includes a touch pad, the unit input unit 120 may be included in the touch pad of the display 140.

When a rear side of the 3D scanner 100 is embodied as illustrated in FIG. 3, the user input unit 120 may be included in a part of the 3D scanner 100 as a hardware configuration such as buttons 10, 20, 30, and 40 or a cylindrical dial component 50.

The user input unit 120 may receive a user command for changing a mode of the 3D scanner 100. That is, the user input unit 120 may receive a user command for changing a mode of the 3D scanner 100 to a hold mode, a reset mode, or a weighting mode.

The hold mode refers to a mode where the 3D scanner 100 pauses the generation of the 3D scan data temporarily while a pause command is input. That is, the pause command may be a user command for temporarily pausing the generation of the 3D scan data.

The reset mode refers to a mode where the 3D scanner 100 deletes first 3D scan data (e.g., previously obtained 3D scan data), and replaces the first 3D scan data with second 3D scan data (e.g., subsequently obtained 3D scan data), for example, 3D scan data based on a result of resuming the 3D scan job while a reset command is input.

The weighting mode refers to a mode where the 3D scanner 100 assigns a weight value to a speed of replacing the previously obtained 3D scan data (e.g., first 3D scan data) with the subsequently obtained 3D scan data (e.g., second 3D scan data) based on an inputted weight value. For example, when a movement of an object to be 3D scanned is large, the 3D scanner 100 may replace the previously obtained 3D scan data with the subsequently obtained 3D scan data more quickly by increasing sensitivity with respect to the weight value. Alternatively, when the movement of the object is not large, the 3D scanner 100 may replace the previously obtained 3D scan data with the subsequently obtained 3D scan data more slowly by reducing the sensitivity with respect to the weight value.

The user input unit 120 may receive a user command for changing a mode of the 3D scanner 100 in phases. For example, when the user input unit 120 includes the cylindrical dial component 50, the 3D scanner 100 may receive a user command for changing a mode of the 3D scanner 100 in phases through the user input unit 120 based on a degree of rotation of the cylindrical dial component 50.

The controller 130 is a component for controlling overall operations of the 3D scanner 100. The controller 130 generates 3D scan data from input data scanned by the scanning unit 110. When the scanning unit 110 includes a depth sensor, the controller 130 may generate 3D scan data based on information about a distance between the 3D scanner 100 and an object to be scanned, which is sensed by the depth sensor.

When a user command for changing a mode of the 3D scanner 100 is input through the user input unit 120, the controller 130 may change a mode of the 3D scanner 100 to a correction mode. The correction mode may be at least one of the hold mode, the reset mode, and the weighting mode.

When the 3D scan job is resumed by the scanning unit 110 while the correction mode is maintained, the controller 130 may correct the first 3D scan data based on the result (e.g., second 3D scan data) of the resumed 3D scan job.

When a user command for changing a mode of the 3D scanner 100 to the hold mode is input, the generation of the first 3D scan data is paused. When the 3D scan job is resumed while the generation of the first 3D scan job is paused, the controller 130 does not resume generating the first 3D scan data. That is, in the hold mode, even when power of the 3D scanner 100 is turned on and it appears that the 3D scan job is performed, the 3D scan job is paused actually, and the first 3D scan data is not generated.

When the user input unit 120 for changing a mode of the 3D scanner 100 to the hold mode is provided in the 3D scanner 100 as a hardware configuration in a form of a button, the hold mode may be maintained while a user presses the button of the user input unit 120 for changing the mode of the 3D scanner 100 to the hold mode.

When a user command for changing the mode of the 3D scanner 100 to the reset mode is input, the controller 130 may replace the first 3D scan data based on second 3D scan data from the resumed 3D scan job.

When the user command for changing the mode of the 3D scanner 100 to the reset mode is input, the controller 130 replaces the previously obtained 3D scan data (e.g., the first 3D scan data) with subsequently obtained 3D scan data (e.g., the second 3D scan data) which is generated by resuming the 3D scan job, even when the first 3D scan data has been previously obtained during the 3D scan job.

In addition, when the user input unit 120 for changing the mode of the 3D scanner 100 to the reset mode is provided in the 3D scanner 100 as a hardware configuration in a form of a button (e.g., a reset button), the reset mode may be maintained while the user presses the reset button. The controller 130 may replace the previously obtained 3D scan data on a same area with the subsequently obtained 3D scan data generated while the user presses the reset button.

When a user command for changing the mode of the 3D scanner 100 to the weighting mode is input, the controller 130 may correct the generated 3D scan data based on a weight value and the subsequently obtained 3D scan data in order to reflect movement of an object to be 3D scanned.

For example, when the sensitivity of the weight value is relatively high, the controller 130 may correct the first 3D scan data by quickly reflecting movement of an objected to be 3D scanned even though the movement of the object is relatively fast. When the sensitivity of the object is relatively low and the movement of the object to be 3D scanned is relatively slowly, the controller 130 may correct the first 3D scan data by slowly reflecting the movement of the object.

In addition, when the user input unit 120 for changing the mode of the 3D scanner 100 to the weighting mode is provided in the 3D scanner 100 as a hardware configuration in a form of the cylindrical dial component 50 or other configuration, the user is able to change the weight value by adjusting the user input unit 120 for changing the mode of the 3D scanner 100 to the weighting mode in phases.

The first 3D scan data may be obtained by respectively obtaining distance information and location information and merging the information. The distance information refers to information regarding a distance between the 3D scanner 100 and an object to be scanned, and may be sensed by the depth sensor included in the scanning unit 110. For example, the controller 130 receives the distance information at an interval of reference unit from the depth sensor. The location information refers to information regarding a location of the 3D scanner 100. The controller 130 may trace the location of the 3D scanner 100 and obtain the location information corresponding to the traced location of the 3D scanner 100. The controller 130 may obtain the first 3D scan data by merging the distance information and the location information.

When merging the distance information and the location information, the controller 130 may correct the first 3D scan data by merging the first 3D scan data and the second 3D scan data (e.g., subsequently obtained 3D scan data from resuming the 3D scan job). That is, in a process of merging the distance information and the location information, the controller 130 may replace the first 3D scan data with the second 3D scan data. In addition, in the process of merging the distance information and the location information, the controller 130 may correct the first 3D scan data based on the inputted weight value and the second 3D scan data.

When the user input unit 120 receives a user command for selecting at least one object from among a plurality of objects to be 3D scanned, the controller 130 may control the 3D scanner 100 to detect at least one selected object, and correct 3D scan data of only the detected object.

Alternatively, when a user command for selecting a subarea of an area where the 3D scan job is performed is input through the user input unit 120, the controller 130 may control the 3D scanner 100 to correct 3D scan data of only the selected subarea.

In addition, the 3D scanner 100 may further include a display 140 configured to have a touch panel. Accordingly, the user command for selecting a subarea of an area where the 3D scan job is performed may be inputted with a touch input through the display 140.

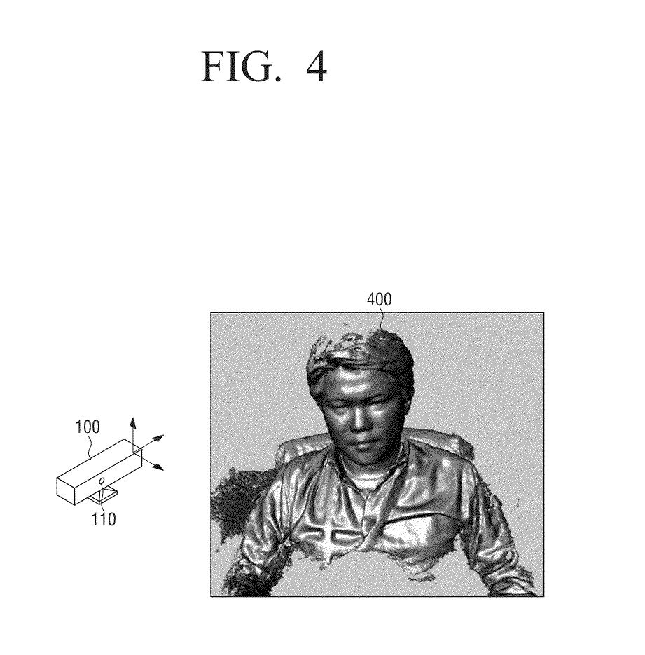

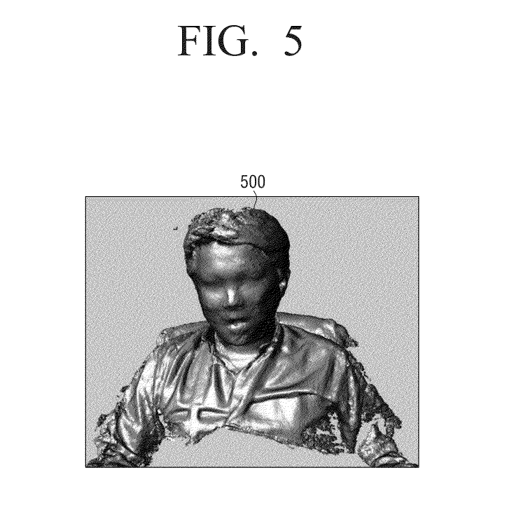

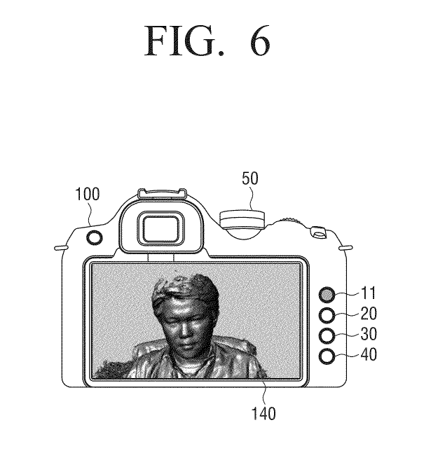

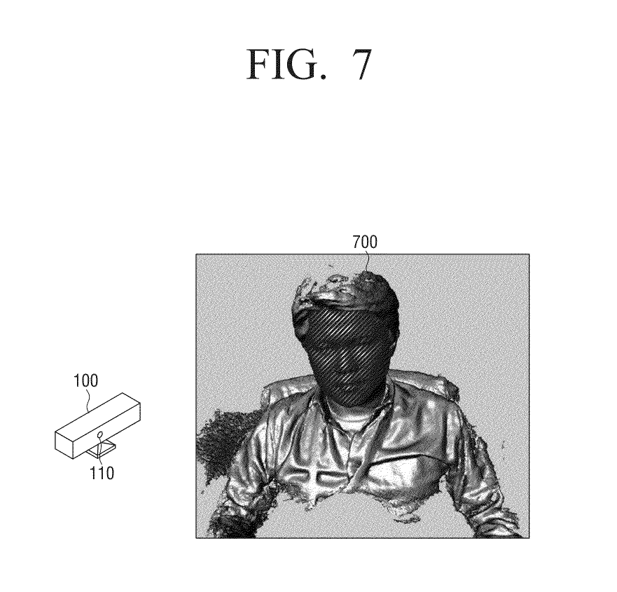

Hereinafter, a process of correcting first 3D scan data based on a result of the resuming the 3D scan job will be described in detail with reference to FIG. 4, FIG. 5, FIG. 6, and FIG. 7.

FIG. 4 is a diagram illustrating a process of obtaining first 3D scan data of a person. When the 3D scanner 100, which is located in front of a person, is rotated a full 360 degrees in a horizontal direction, a 3D image 400 as illustrated in FIG. 4 may be obtained.

However, in order to obtain the 3D image 400 as illustrated in FIG. 4, it is required for the person to be scanned not to move substantially and not to change a facial expression while the 3D scan job is performed.

As described above, the first 3D scan data is obtained based on an average value which is obtained while the 3D scan job is performed, and thus, a face of the scanned person in the 3D image may be changed beyond recognition by a slight change of a facial expression as illustrated in FIG. 5. Accordingly, the 3D scan job should be performed again if it is not possible to distinctly recognize the face of the scanned person even though parts of the 3D image other than the face are usable.

In order to reduce the aforesaid inconveniences, the reset mode may be used. FIG. 6 is a diagram illustrating a process of selecting a button 11 which changes a mode of the 3D scanner 100 to the reset mode and performing the 3D scan job with respect to a face of the person.

While the button 11, which changes the mode of the 3D scanner 100 to the reset mode, is selected and the reset command is input, the controller 130 deletes the first 3D scan data corresponding to the face of the person which was previously obtained and replaces the first 3D scan data corresponding to the face with second 3D scan data obtained from resuming the 3D scan job.

By doing this, only the first 3D data corresponding to the face 700 of the scanned person is changed as illustrated in FIG. 7.

By the aforementioned 3D scanner 100, when the first 3D scan data is generated inaccurately, a user is able to resume the 3D scan job with respect to only a selected area and generate second 3D scan data of the selected area, and thus, avoid the inconvenience of performing the entire 3D scan job again.

By contrast, when a button which changes the mode of the 3D scanner 100 to the hold mode is selected, the controller 130 may pause the 3D scan job while the pause command is input. Accordingly, when the button which changes the mode of the 3D scanner 100 to the hold mode is selected again, the controller 130 may control the 3D scanner 100 to resume the 3D scan job.

Alternatively, the controller 130 may pause the 3D scan job while the button which changes the mode of the 3D scanner 100 to the hold mode is pressed.

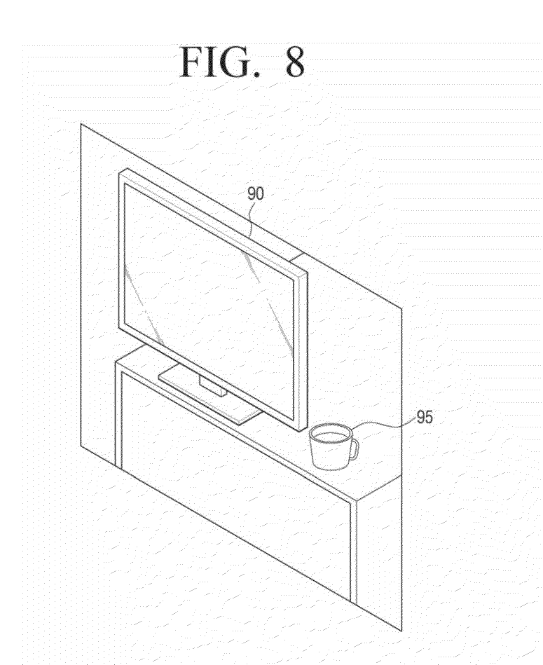

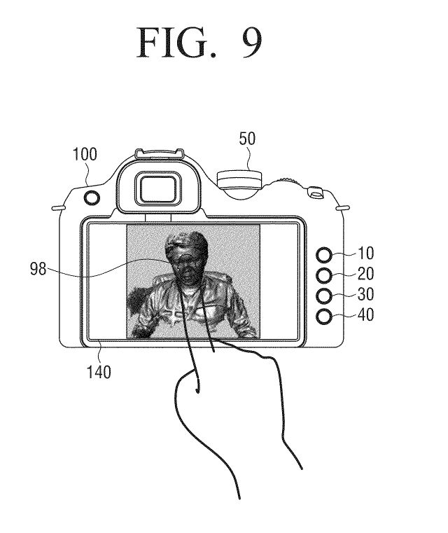

As illustrated in FIG. 8 and FIG. 9, the controller 130 may correct only the first 3D scan data corresponding to at least one object or a selected area from the objects to be scanned.

FIG. 8 is a diagram illustrating a process of detecting an object from a 3D scan screen according to an embodiment.

As illustrated in FIG. 8, when the 3D scan job is performed with respect to a monitor 90 and a cup 95 laid on a desk, at least one object may be selected by a user command for selecting the monitor or the cup.

For example, when the 3D scanner 100 includes the display 140 including the touch panel, and a touch command for selecting the cup 95 is input on the display 140 from the user, the controller 130 may select the cup 95 from the 3D scan screen.

Alternatively, the 3D scan job with respect to the cup 95 is performed repetitively, the controller 130 may detect and recommend the cup 95 to the user through the display 140 even without an input of a user command.

When the cup 95 is detected automatically or manually as described above, and the detected cup 95 is selected by the user input unit 120, the controller 130 may correct the 3D scan data of only the cup 95.

That is, the controller 130 may replace only the first 3D scan data corresponding to the cup 95 with the second 3D scan data from the resumed 3D scan job. Alternatively, the controller 130 may correct the first 3D scan data of the cup 95 by assigning a weight value to the second 3D scan data of the cup 95. The controller 130 may control the 3D scanner 100 to pause the 3D scan job with respect to the cup 95 only.

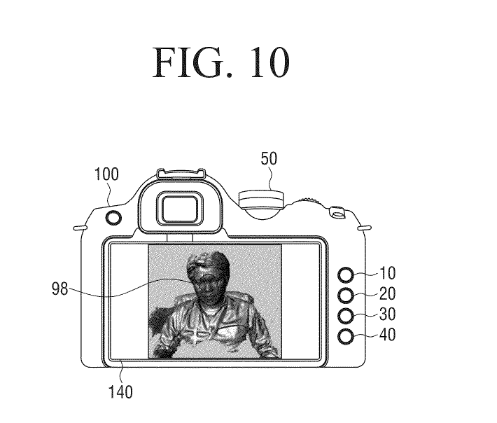

As illustrated in FIG. 9, when the 3D scanner 100 includes the display 140 including the touch panel, the 3D scanner 100 may receive a user command of selecting an area of the display 140. In addition, as illustrated in FIG. 10, the display 140 may shade and display a selected area 98 which is selected by the user command. Alternatively, the display 140 may display the selected area 98 differently by varying a color of the selected area 98.

As described above, when the selected area 98 is selected through the user input unit 120, the controller 130 may correct the 3D scan data of only the selected area 98.

That is, the controller 130 may replace only the first 3D scan data that corresponds to the selected area 98 with the second 3D scan data from the resumed 3D scan job. Alternatively, the controller 130 may correct only the first 3D scan data corresponding to the selected area 98 by assigning a weight value to the second 3D scan data.

In addition, the controller 130 may control the 3D scanner 100 to pause the 3D scan job with respect to only the selected area 98.

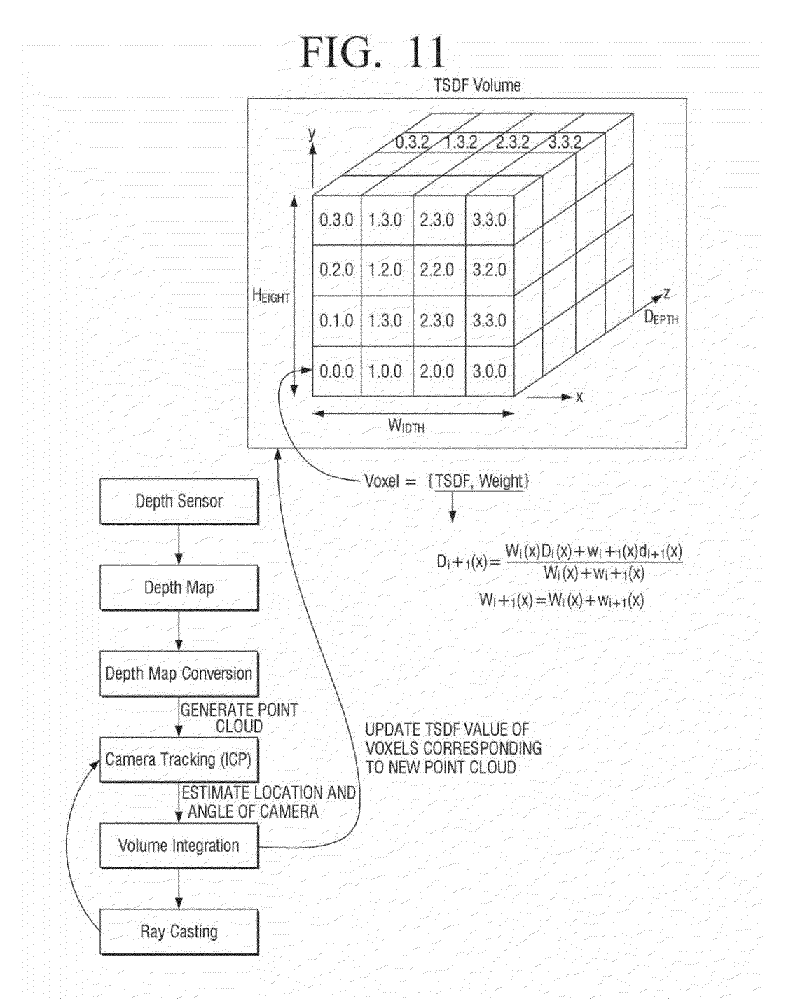

FIG. 11 is a flow chart illustrating a 3D scan process according to an embodiment.

FIG. 11 illustrates a method where the 3D scanner 100 includes a depth sensor and the depth sensor obtains a 3D image by sensing a distance between the 3D scanner 100 and a surface of an objected to be scanned.

The depth sensor outputs the sensed distance information in a form of a depth map. A depth map conversion process is a process of performing a coordinate variation which converts a depth map image expressed as a U coordinate and a V coordinate of the depth sensor into an actual coordinate and shows a location of the sensed coordinate on 3D coordinates, and making a Point Cloud.

A camera tracking process, such as an iterative closest point (ICP) process, is a process of estimating a movement of the 3D scanner 100. That is, the camera tracking process is a process of estimating a location and angle of the 3D scanner 100 at which the depth map was obtained by using an ICP algorithm. The ICP algorithm has been explained in various related references, and thus, the detailed description is omitted.

A volume integration process is a process for merging a previously built 3D model and a newly obtained Point Cloud. A voxel that is a basic unit of volume is expressed as a Truncated Signed Distance Function (TSDF) value and a weight value. The TSDF value is a function value where an empty area close to the 3D scanner 100 is expressed as a positive number, a surface is expressed as 0, and an inner side of the surface is expressed as a negative number with reference to the surface of an object to be 3D scanned. A TSDF data structure has been explained in various related references, and thus, the detailed description is omitted.

In order to correct the 3D scan data by updating the new Point Cloud to the existing TSDF volume, a weight function is used. A TSDF value of each voxel of the TSDF volume is updated by using the new Point Cloud and the weight value. Where the TSDF is expressed as D(x), the updated TSDF value Dᵢ₊₁(x) is expressed as Equation 1 below.

$${D}_{i + 1} = \frac{{W}_{i} ( x ) {D}_{i} ( x ) + {w}_{i + 1} ( x ) {d}_{i + 1} ( x )}{{W}_{i} ( x ) + {w}_{i + 1} ( x )} \qquad [ Equation 1 ]$$

Meanwhile, when the weight value function is expressed as W(x), the updated weight function value Wᵢ₊₁(x) is expressed as Equation 2 below.

Wᵢ₊₁(x)=Wᵢ(x)+wᵢ₊₁(x) [Equation 2]

That is, a value of W(x) becomes 0 in the reset mode, and the new TSDF value is not reflected in the hold mode. In the weighting mode, the weight function is expressed as Equation 3 below.

Wᵢ₊₁(x)=(W(x)*a)+Wᵢ₊₁(x) [Equation 3]

When the sensitivity of the weight value becomes high by a user command, the value a becomes a positive number below 1. In addition, the sensitivity of the weight value becomes low by the user command, the value a becomes a positive number above 1.

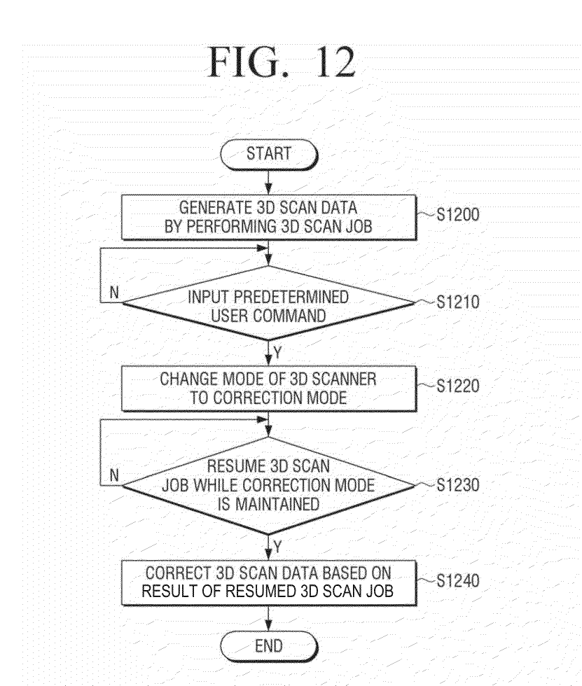

FIG. 12 is a flow chart illustrating a 3D scanning method of a 3D scanner 100 according to an embodiment.

The 3D scanner 100 performs a 3D scan job and generates 3D scan data (S1200). The 3D scan data may be generated by merging the distance information (e.g., information about a distance between the 3D scanner 100 and an object to be scanned) and the location information of the 3D scanner 100.

The 3D scanner 100 determines whether a predetermined user command is input (S1210). When the user input unit 120 is provided as a hardware configuration in a form of a button or a cylindrical dial component, the predetermined user command may be input in phases by pressing the button or turning the cylindrical dial component. Alternatively, when the 3D scanner 100 includes the display 140 including the touch panel, the predetermined user command may be a touch input.

When the predetermined user command is input (Y at S1210), the mode of the 3D scanner 100 is changed to the correction mode. The correction mode may include the hold mode, the reset mode, or the weighting mode.

The hold mode refers to a mode which pauses the 3D scan job temporarily while the pause command is input. That is, the pause command may be a user command for temporarily pausing the 3D scan job.

The reset mode refers to a mode which deletes the previously obtained 3D scan data (e.g., first 3D scan data) while a reset command is input, and replaces the first 3D scan data with second 3D scan data from the resumed 3D scan job.

The weighting mode refers to a mode where the 3D scanner 100 assigns a weight value to a speed of replacing the first 3D scan data with the second 3D scan data based on an inputted weight value. For example, when a movement of an object to be 3D scanned is large, the 3D scanner 100 may replace the first 3D scan data with the second 3D scan data more quickly by increasing sensitivity with respect to the weight value. Alternatively, when the movement of the object is not large, the 3D scanner 100 may replace the first 3D scan data with the second 3D scan data more slowly by reducing the sensitivity with respect to the weight value.

The 3D scanner 100 determines whether the 3D scan job is resumed while the 3D scan correction mode is maintained (S1230). When it is determined that the 3D scan job is resumed (Y at S1230), the 3D scanner 100 corrects the 3D scan data based on the resumed 3D scan job (S1240).

For example, while a user input button for changing the mode of the 3D scanner 100 to the reset mode is pressed by a user, the mode may be changed to the reset mode, and the 3D scan job may be resumed in the reset mode. Accordingly, the first (e.g., previously obtained) 3D scan data may be replaced based on the second (e.g., subsequently obtained) 3D scan data. When the user input button for changing the mode of the 3D scanner 100 to the reset mode is no longer pressed, the reset mode may be released.

The 3D scanning method of the 3D scanner according to various embodiments may be coded as software and stored in a non-transitory readable medium. The non-transitory readable medium may be mounted and used on various devices.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A three dimensional (3D) scanning method comprising:
generating first 3D scan data by performing a 3D scan job;
when a predetermined user command is input, changing a mode of the 3D scan job to a correction mode; and
when the 3D scan job is resumed while the correction mode is maintained, correcting the first 3D scan data based on second 3D scan data generated by resuming the 3D scan job.

2. The method as claimed in claim 1, wherein the correcting comprises replacing the first 3D scan data with the second 3D scan data.

3. The method as claimed in claim 1, wherein the correcting comprises correcting the first 3D scan data by assigning a weight value to the second 3D scan data and merging the first 3D scan data with the weighted second 3D scan data.

4. The method as claimed in claim 1, wherein generating the first 3D scan data comprises:
receiving distance information at an interval of reference unit;
tracing a location of a 3D scanner which performs the 3D scan job; and
merging the distance information with location information corresponding to the traced location of the 3D scanner;
wherein the correcting comprises merging the first 3D scan data with the second 3D scan data.

5. The method as claimed in claim 1 further comprising:
detecting an object;
wherein the correcting comprises correcting only the first 3D scan data that corresponds to the detected object.

6. The method as claimed in claim 1 further comprising:
receiving a user command of selecting a subarea of an area where the 3D scan job is performed;
wherein the correcting comprises correcting 3D scan data of the subarea selected by the user command.

7. A three dimensional (3D) scanner comprising:
a scanning unit that performs a 3D scan job;
a user input unit that receives a user command; and
a controller that generates first 3D scan data from input data scanned by the scanning unit, when a user command for changing a mode of the 3D scanner is input, changes the mode to a correction mode, and when the 3D scan job is resumed while the correction mode is maintained, corrects the first 3D scan data based on second 3D scan data from the resumed 3D scan job.

8. The 3D scanner as claimed in claim 7, wherein the scanning unit comprises a depth sensor that senses distance information.

9. The 3D scanner as claimed in claim 7, wherein the controller corrects the first 3D scan data by replacing the first 3D scan data with the second 3D scan data from the resumed 3D scan job.

10. The 3D scanner as claimed in claim 7, wherein the controller corrects the first 3D scan data by assigning a weight value to the second 3D scan data from the resumed 3D scan job.

11. The 3D scanner as claimed in claim 7, wherein the controller receives distance information at an interval of reference unit, traces a location of the 3D scanner, generates the first 3D scan data by merging the distance information based on the traced location of the 3D scanner, and when the distance information is merged based on the traced location of the 3D scanner, merges the first 3D scan data with the second 3D scan data from the resumed 3D scan job.

12. The 3D scanner as claimed in claim 7, wherein when a user command for selecting an object is input through the user input unit, the controller detects the selected object, and corrects the first 3D scan data corresponding to the detected object.

13. The 3D scanner as claimed in claim 7, wherein when a user command of selecting a subarea of an area where the 3D scan job is performed is input through the user input unit, the controller corrects only the first 3D scan data corresponding to the subarea selected by the user command.

14. The 3D scanner as claimed in claim 13 further comprising:
a display having a touch panel,
wherein the user command of selecting a subarea of an area where the 3D scan job is input with a touch input through the display.

15. A three dimensional (3D) scanning method comprising:
generating first 3D scan data by performing a 3D scan job;
when a predetermined user command is input, pausing the generation of the first 3D scan job; and
when the 3D scan job is resumed while the generation of the first 3D scan data is paused, resuming the 3D scan job without generating the first 3D scan data.

16. The method as claimed in claim 15, wherein when the predetermined user command is selected again while the generation of the first 3D scan data is paused, the resuming comprises resuming the generating of the first 3D scan data.

17. A three dimensional (3D) scanner comprising:
a scanning unit that performs a 3D scan job;
a user input unit that receives a user command; and
a controller that generates first 3D scan data from input data scanned by the scanning unit, when a user command for pausing the scan job of the 3D scanner is input through the user input unit, pauses the generation of the first 3D scan data, and when the 3D scan job is resumed while the generation of the first 3D scan data is paused, resumes the 3D scan job without generating the first 3D scan data.

18. The scanner as claimed in claim 17, wherein when the user command is selected again through the user input unit while the generation of the first 3D scan data is paused, the controller resumes generating the first 3D scan data.
